(19) United States
(12) Patent Application Publication
(10) Pub. No.: US 2005/0136205 A1
(43) Pub. Date: Jun. 23, 2005

(54) Thermoplastic multilayer composite

(76) Inventors: Georg Stoppelmann, Bonaduz (CH); Paul Schwitter, Schanis (CH); Andre Sturzel, Igis (CH)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/004,967

(22) Filed: Dec. 7, 2004

Related U.S. Application Data
(60) Provisional application No. 60/528,793, filed on Dec. 12, 2003.

(30) Foreign Application Priority Data
Dec. 12, 2003 (CH) 02125/03

(51) Int. Cl. B32B 1/08

(52) U.S. Cl. 428/36.91; 428/35.7

(57) ABSTRACT

A thermoplastic multilayer composite comprising at least one first layer comprising a fluoropolymer, and also of at least one other second layer, at least some regions of which have direct contact with the first layer. This multilayer composite achieves surprisingly excellent adhesion between the two layers, because the second layer is comprising polyamide-polyamine copolymers. This second layer may particularly advantageously be used as an adhesion-promoter layer in relation to a further, third layer, which, by way of example, is comprising polyamide. In the form of a hollow body or hollow profile, this structure comprising at least 3 layers can preferably be used as fuel piping in the motor vehicle sector.

### TECHNICAL FIELD

The present invention relates to a thermoplastic multilayer composite composed of at least one first layer composed of fluoropolymers, and also of at least one other, second layer, at least regions of which have direct contact with the first layer.

### PRIOR ART

Polyamides alone are unsuitable for many applications, as are fluoropolymers alone. By way of example, polyamides are not weather-resistant, because they age on exposure to light and absorb atmospheric moisture. This can lead to discoloration and to impairment of mechanical properties. Although polyamides have very good mechanical properties, for example good toughness etc., they have poor barrier action with respect to polar substances, which therefore can readily migrate through polyamides. By way of example, this is undesirable in fuel piping for alcohol-containing fuels, in view of the constantly increasing stringency of environmental and safety regulations.

Another disadvantage particularly applicable to single-layer fuel piping composed of polyamide, specifically of polyamide 11 or 12, is that the polymers have considerable ability to absorb specific constituents of the fuels, and this leads to swelling and therefore to changes in length and also changes in thickness of the pipe.

Developments disclosed from the USA propose the use of fluoropolymers as barrier layers in this type of situation. These polymers are firstly very expensive and secondly difficult to process, create disposal problems, and when processed by coextrusion have only low adhesion or are substantially incompatible with polyamides, giving inadequate adhesion between the laminate layers during production of multilayer composites. However, in industrial applications it is essential that a thermoplastic multilayer composite provides a strong bond.

Development work has therefore been carried out in order to improve these systems.

DE-A-4326130 describes, by way of example, multilayer composites, in particular two-layer composites, composed of a layer composed of polyamide and of another layer composed of polyvinylidene fluoride (PVDF). The problem of the strong bond is solved by adding polymethacrylamide to PVDF. In other words, no adhesion-promoter layer is used here, and instead of this the layer composed of fluoropolymer is modified so as to permit adhesion to the layer composed of polyamide. However, a disadvantage with pipes which use PVDF as barrier layer is that their flexibility is low, and this can lead to buckling of the pipe when bending radii are small. EP-A-0511094 takes another approach, likewise describing a two-layer composite with a first layer composed of a fluoropolymer and with a second layer composed of polyamides, good adhesion between these two chemically very different layers being provided via corona activation of the layer composed of fluoropolymer. Here again, therefore, no adhesion-promoter layer is used. U.S. Pat. No. 6,524,671 likewise describes a two-layer structure with a first layer composed of a fluoropolymer (specifically a copolymer with TFE) and with a second layer composed of a polyamide. In order to provide satisfactory adhesion between these two layers, that document proposes a chemical modification of the polyamide layer. This polyamide layer is modified using polar groups, by way of example with formation of a graft copolymer composed of maleic anhydrides and of unsaturated hydrocarbons.

Other documents describe specific adhesion-promoter layers capable of providing sufficient adhesion between the first layer composed of a fluoropolymer and a second layer composed of polyamide.

By way of example, U.S. Pat. No. 5,576,106 proposes, as adhesion-prometer layer, a fluoropolymer which, with exposure to ionizing radiation, has been grafted on the surface of the particles. The fluoropolymer used here comprises ETFE or PVDF, and maleic anhydride, inter alia, is proposed as graft reagent.

EP-A-0767190 describes a multilayer composite with an inner layer composed of fluoropolymer and with an outer layer composed of polyamide, where between these there is an adhesion-promoter layer which is composed of a fully polymerized polyamide and of a subsequently admixed diamine, such as decanediamine. It is stated here that the presence of additionally, free diamine increases the ratio of amino groups to carboxy groups, thus permitting achievement of better adhesion.

U.S. Pat. No. 5,284,184 likewise describes pure piping which, as inner layer, has a layer composed of fluoropolymer, and has a layer of polyamide as outer layer. Between these, there is a thermoplastic adhesion-promoter layer, specific examples proposed for this being polyvinylidenefluorides, polyvinyl fluorides, polyvinyl acetate/urethane blends, and mixtures of these.

U.S. Pat. No. 5,891,538 describes a multilayer structure in which, as adhesion promoter between the fluoropolymer and the polyamide, a blend composed of these two systems is proposed, specifically a mixture composed of polyamide and of fluororesins and fluororubber.

U.S. Pat. No. 5,383,087 describes multilayer pipes with fluoropolymer inner layer and with an outer layer composed of polyamide 6, polyamide 12, or polypropylene. Fluoropolymer/polyamide blends are used as adhesion promoter between these two layers.

However, adhesion promoters composed of blends composed of fluoropolymer and polyamide merely use physical interactions and therefore have relatively low adhesion values. Furthermore, the use of a fluoropolymer/polyamide blend is problematic, because the long-term result is dehydrofluorination of the fluoropolymers and degradation of the fluoropolymers. The resultant hydrogen fluoride is a highly corrosive gas which irritates the respiratory tract, these factors mostly being unacceptable for environmental and safety reasons.

EP-A-0670774, too, describes an adhesion promoter which can be used for these applications, the adhesion-promoter layer being provided from a blend composed of polyamide and polyvinylidene fluoride.

EP-A-0637509 describes five-layer pipes composed of fluoropolymers, polyesters and polyamides. The two adhesion-promoter layers are composed of thermoplastic polyurethane, polyether block amides, polyester block amides polyolefins, and polyester copolymers.

### SUMMARY OF THE INVENTION

The invention is based on the object of providing a layer which is composed of polyamide and which can be bonded directly with strong adhesion to thermoplastically processable fluoropolymers, in particular to fluoropolymers composed of TFE, HFP and VDF, e.g. in a coextrusion process, and moreover can preferably serve as adhesion-promoter layer with layers composed of polyamides. A further object is to provide thermoplastic multilayer composites composed of these fluoropolymer moulding compositions and polyamide moulding compositions. The moulding compositions and the thermoplastic multilayer composites produced therefrom are to adhere strongly to one another in the thermoplastic multilayer composite; they are particularly preferably to be resistant to fuels and to exhibit sufficiently low permeation. Specifically the object is therefore to propose an improved thermoplastic multilayer composite composed of at least one first layer composed of fluoropolymers, and also of at least one other layer, at least some regions of which have direct contact with the first layer.

This object is achieved in that the second layer is composed of polyamide-polyamine copolymers.

The heart of the invention therefore consists in providing good adhesion to the layer composed of fluoropolymer by using, as adherent layer, a polyamide-polyamine copolymer. Very surprisingly, these copolymers have been found to permit markedly better adhesion.

The invention therefore in particular provides a layer composed of polyamide, or a novel adhesion promoter composed of polyamide-polyamine copolymer and bonded with strong adhesion to thermoplastically processable fluoropolymers, or bonding these fluoropolymers with strong adhesion to other layers composed of polyamides. Layers composed of the inventive adhesion-promoter polyamide-polyamine copolymer compositions can be used as intermediate layers in multilayer composites, to achieve bonding of the individual layers with strong adhesion.

However, the invention also provides the multilayer composites with no third or further layer, in which the second layer is therefore also a surface layer (e.g. outer layer).

It should also be pointed out that these polyamide-polyamine copolymers have previously been mentioned in the prior art as components in blends for adhesion-promoter layers. By way of example, reference may be made to EP-A-1216825 or EP-A-1216826, which in principle describe a multilayer composite which comprises a layer composed of a moulding composition composed of polyamide (preferably polyamide 6, polyamide 66 or polyamide 6/66, or else a mixture of these), optionally treated with a polyamine-polyamide copolymer, and also with some content by weight of another polyamide (preferably polyamide 11, polyamide 12, polyamide 612, polyamide 1012, polyamide 1212, or else a mixture of these) and also, if appropriate, adjacent thereto, a layer composed of ethylene-vinyl alcohol copolymer (EP-A-1216826). The layer composed of polyamide is preferably arranged on the outer side in the case of a pipe here. The object here is in essence either to provide a polyamine-polyamide copolymer as compatibilizer in the moulding composition composed of polyamide or, in the absence of this polyamine-polyamide copolymer, to set the compounding temperature sufficiently high that transamidation reactions take place during the process and, during the compounding process, lead to polyamide block copolymers which assume the function of the compatibilizer. This procedure is preferably also supported via addition of appropriate catalyst, such as hypophosphorous acid, dibutyltin oxide, triphenylphosphine or phosphoric acid.

However, nowhere in these documents is there any comment to the effect that a polyamide-polyamine copolymer, in particular a polyamine-polyamide copolymer without further fractions of polyamide in the mixture, could sometimes have good adhesion properties in relation to fluoropolymer layers. Nor does that document render obvious this completely different use as adhesion promoter for fluoropolymer layers, because it always concerns only adhesion promoters in relation to layers that are chemically entirely different, e.g. polyamides or ethylene-vinyl alcohol copolymers.

Other documents which describe polyamide-polyamine copolymers, e.g. EP-A-1065236, EP-A-1217041, EP-A-1216823, and also U.S. Pat. No. 3,442,975 have to be regarded in the same way as EP-A-1216825 and EP-A-1216826, because they too make no reference to possible adjacent layers composed of fluoropolymers.

One first preferred embodiment of the multilayer composite is characterized in that the fluoropolymer has been selected from fluoropolymers composed of monomers such as tetrafluoroethylene (TFE), hexafluoropropylene (HFP), vinyl fluoride (VF), perfluorinated methyl vinyl ether (PMVE) or vinylidene fluoride (VDF), or of a mixture thereof, with or without ethylene. Use may be made of homo- or copolymers. The first layer is particularly preferably a layer composed of ethylene-tetrafluoroethylene copolymers (ETFE) or composed of polyvinylidene fluoride (PVDF). The fluoropolymer may also be a copolymer composed of PVDF. This layer does not have to (but may) be modified, e.g. by surface treatment (cf. EP-A-0551094) or by chemical modification of the fluoropolymer (cf. DE-A-4326130), in order to provide good adhesion to the second layer. In other words, this is preferably a layer composed of fluoropolymers and not modified with respect to adhesion.

As previously mentioned at the outset, in another preferred embodiment of this thermoplastic multilayer composite it may take the form of a hollow body (which here and hereinafter also covers hollow profiles) or take the form of a coating, where, in the case of a multilayer composite which is a hollow body, the first layer is preferably a layer facing towards the inner side of the hollow body. It is moreover preferable that the second layer act as an adhesion promoter in relation to a third layer, i.e. that at least some regions of the second layer have direct contact with a third layer, particularly preferably composed of polyamides. Particularly good adhesion can be achieved between the second and the third layer if the polyamide-polyamine copolymers of the second layer and the polyamides of the third layer are at least to some extent similar, or if, again preferably, at least 95% of the monomers of the second layer and of the third layer are identical.

A feature of another preferred embodiment is that the multilayer composite is a hollow body, where the first layer is a layer at least indirectly facing towards the inner side of the hollow body (although the arrangement may also have further layers on the inner side), and where the third layer is a layer at least indirectly facing towards the outer side of the hollow body, and where the layers preferably in essence have direct full-surface contact with one another.

It is preferable that the polyamide-polyamine copolymers of the second layer and/or the polyamides of the third layer are polymers or polycondensates composed of aliphatic lactams or of ω-aminocarboxylic acids having from 4 to 44 carbon atoms, preferably from 4 to 18 carbon atoms, in particular 12 carbon atoms, or are polymers or polycondensates composed of aromatic ω-aminocarboxylic acids having from 6 to 20 carbon atoms. Alternatively or additionally, the polyamide-polyamine copolymers of the second layer and/or the polyamides of the third layer may be polycondensates composed of at least one diamine and of at least one dicarboxylic acid, in each case having from 2 to 44 carbon atoms. The diamines are at least one or more of the diamines selected from the following group: ethylenediamine, 1,4-diaminobutane, 1,6-diaminohexane (=hexamethylenediamine), 1,10-diaminodecane, 1,12-diaminododecane, m- and p-xylylenediamine, cyclohexyldimethyleneamine, bis(p-aminocyclohexyl)-methane and their alkyl derivatives, and/or the dicarboxylic acids are one or more of the following dicarboxylic acids: succinic, glutaric, adipic, pimelic, suberic, azelaic and sebacic acid, dodecanedicarboxylic acid, 1,6-cyclohexanedicarboxylic acid, terephthalic acid, isophthalic acid and naphthalenedicarboxylic acid. However, the specified lactams or ω-aminocarboxylic acids are in particular preferred as units together with polyamines, e.g. (branched) polyethyleneimines, for the preparation of the polyamide-polyamine copolymers.

In another preferred embodiment of the present invention, the basis for the polyamide-polyamine copolymers of the second layer and/or the polyamides of the third layer is homo- and copolyamides selected from PA 6, PA 11, PA 46, PA 12, PA 1212, PA 1012, PA 610, PA 612, PA 69, PA 6T, PA 6I, PA 10T, PA 12T, PA 12I, mixtures of these or copolymers composed of these polyamides, particular preference being given to PA 11, PA 12, PA 1212, PA 10T, PA 12T or to copolymers composed of the abovementioned polyamides, in particular PA 12T/12, PA 10T/12, PA 12T/106 and PT 10T/106. The basis of the polyamide-polyamine copolymers of the second layer and/or the polyamides of the third layer may also be PA 6/66, PA 6/612, PA 6/66/610, PA 6/66/12, PA 6/6T and PA 6/6I. These polyamides or polyamide-polyamine copolymers may receive additions of other polymers, in particular polymers or copolymers composed of polyolefin, grafted with acrylic acid or grafted with maleic anhydride, and/or of additives, such as UV stabilizers and heat stabilizers, crystallization accelerators, plasticizers, flame retardants, impact modifiers and lubricants.

In another preferred embodiment of the present invention, the polyamines employed to prepare the polyamide-polyamine copolymers for the second layer are polyvinylamines, polyamines (e.g. prepared from alternating polyketones, as described in DE-A-196 54 058), dendrimers, or particularly preferably linear or branched polyethyleneimines. If they are linear or branched polyethyleneimines, these preferably have a molar mass in the range from 500 to 25 000 g/mol, in particular from 800 to 5000 g/mol. They also preferably feature a viscosity in the range of from about 1200 to about 5000 mpa*s at 20° C.

Typically, the moulding composition of the second layer (i.e. the polyamide-polyamine copolymer) is characterized by an amino end group concentration in the range from 50 to 300 μeq/g. It preferably also has a volume flow index (MVR, melt volume rate) of from 10 to 50 cm³/10 min at 275° C./5 kg to ISO 1133. The volume flow index MVR (melt volume rate, previous MVI, melt volume index) is the volume flow index in cm³ per 10 minutes, measured with a melting time of 4 minutes at 275° C. and a load of 5 kg, using standardized MVR equipment.

The first layer composed of fluoropolymer may also particularly preferably have been rendered antistatic via admixture of carbon black particles or of graphite particles or of other electrically conductive additives. Under these conditions it is typically extremely difficult to provide good adhesion to a further layer composed of polyamides, but this can be achieved in the present instance using the inventive moulding composition for layer 2.

The inventive moulding composition for the second layer is characterized in that it comprises polyamine, particularly preferably polyethyleneimine, in a preferred amount of from 0.2 to 5% by weight, more preferably in an amount of from 0.4 to 1.5% by weight, as co-component in the polyamide-polyamine copolymer, the remaining co-fractions of the copolymer preferably being composed of polyamide. However, other additives may likewise be present in the second layer, examples being impact modifiers, plasticizers, etc.

Other preferred embodiments of the inventive multilayer composites are described in the dependent claims.

The present invention also provides a use of a layer composed of polyamide-polyamine copolymers, in particular composed of polyamide-polyethyleneimine copolymers, as adherent layer in relation to fluoropolymer substrates, in particular for the provision of adhesion between substrates composed of fluoropolymer and layers composed of polyamides. In other words, the second layer of the abovementioned multilayer composite preferably act as adhesion promoter.

The present invention also provides the use of a thermoplastic multilayer composite as described above as fluid-conveying piping or containers, in particular in the motor vehicle sector, for example as fuel piping for, by way of example, petrol or diesel. An alternative use is as coating of optical conductors (optical wave guides) in particular with an optical core composed of PMMA, where the layer facing towards the PMMA is the layer composed of fluoropolymer.

The present invention also provides polymer piping encompassing a multilayer composite of the type described above, characterized in that the first layer is at least indirectly an inner layer with a thickness in the range from 0.01 to 0.7 mm, the second layer, in contact therewith, is an adhesive-promoter layer with a thickness of from 0.05 to 0.3 mm, and the third layer is, at least indirectly, an outer layer with a thickness of from 0.2 to 0.8 mm.

It is generally true that at least one of the layers of the polymer piping, preferably the inner layer, may be electrically conducting, and/or the inner side of the first layer may have another, innermost layer which is electrically conductive and whose polymer basis is preferably the same as that of the first layer.

Finally, the present invention provides a process for the production in particular of a hollow body composed of a thermoplastic multilayer composite of the type described above, characterized in that, for the preparation of the moulding composition for the second layer a lactam (or the ω-aminocarboxylic acid), the polyamine, in particular a polyethyleneimine, and also water, are first homogenized at an elevated temperature, and then, at a further elevated temperature above 300° C., are polymerized for two or more hours at an elevated pressure, and also then brought to atmospheric pressure and a lower temperature, to give the polyamide-polyamine copolymer. The first layer, the second layer, and also, if present, the third layer and, if appropriate, other outer or inner layers may be joined in a coextrusion process, particularly preferably to give a pipe or piping or a container.

The inventive multilayer composites are used in engineering components in the sector of the electrical, mechanical engineering and automotive industries, and also in the field of optical data transfer, wherever physical/optical reasons cause a fluoropolymer to be used as first layer to coat the optical wave guide. They are also particularly used as films or as multilayer pipes, e.g. in the sector of the motor vehicle industry. The invention therefore also provides a polyamide-polyamine copolymer adhesion promoter which can particularly be used in the coextrusion process in order to bond pipes composed of polyamide (in particular composed of polyamide 12) and of fluoropolymers, e.g. ETFE, or of a terpolymer composed of VDF, TFE and HFP to one another with strong adhesion. This bond between the individual layers is present directly after pipe extrusion and remains even after these inventive multilayer pipes have had contact with fuel.

### BRIEF DESCRIPTION OF THE FIGURES.

Examples will be used below for further illustration of the invention in connection with the drawing.

FIG. 1 shows an axial section through fuel piping with a multilayer structure.

### METHODS FOR WORKING THE INVENTION

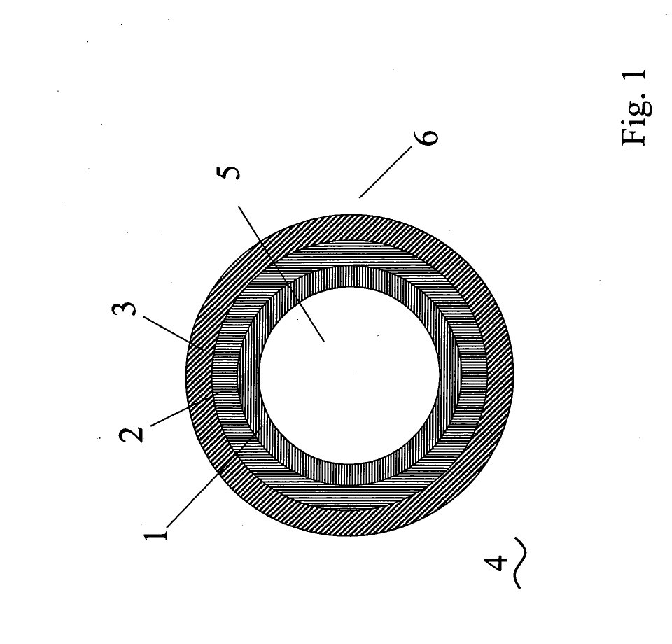

FIG. 1 shows a general structure of fuel piping composed of a thermoplastic multilayer composite 4, intended to serve as an example of the present invention. The piping encompasses an inner space 5 enclosed, towards the outside, firstly by a first layer, the inner layer 1. Immediately in contact with the inner layer 1 there is a second layer, an adhesion-promoter layer 2. A third layer, the outer layer 3, delimits the fuel piping in relation to the outer space 6, and has direct contact with the intermediate layer 2. Use may also be made of other layers not shown which, by way of example, have been arranged towards the inner space 5 or towards the outer space 6.

The invention proposes use of a layer composed of fluoropolymers for the inner layer 1. This type of layer has an ideal barrier function. This type of first layer is particularly preferably a layer composed of ethylene-tetrafluoroethylene (ETFE) (cf., by way of example, Kunststoff-Kompendium [Plastics Compendium], A. Franck and K. Biederbick, 2nd edition, 1988, p. 112, and also p. 153; or Kunststoff Taschenbuch [Plastics Handbook], K. Oberbach, 28th edition, 2001, p. 23 and also p. 469). Typically, this is an approximately alternating copolymer composed of about 25% by weight of ethene and 75% by weight of tetrafluoroethene, i.e. a copolymer having a molar ratio of about 1.2:1. Alternatively, it is possible to form the inner layer from poly(vinylidene fluoride) (PVDF), by way of example (cf. Kunststoff-Kompendium [Plastics Compendium], A. Franck and K. Biederbick, 2nd edition, 1988, p. 152; or Kunststoff Taschenbuch [Plastics Handbook], K. Oberbach, 28th edition, 2001, p. 23 and also p. 467), a semicrystalline thermoplastic material.

The outer layer, the third layer 3, is a layer composed of polyamide, preferably composed of polyamide 12. Additives, e.g. impact modifiers and/or other additives, may have been added to this layer.

Adhesion-promoter systems for ETFE copolymers or for PVDF copolymers are difficult to prepare, in particular if adhesion to a further layer composed of polyamide has to be provided simultaneously.

One possibility is corona treatment of the ETFE layer followed by coating with polyamide, as previously mentioned in the prior art (cf. EP-A-0551094). A disadvantage is the low extrusion speed and the difficulty of achieving constant adhesion values. Other possible solutions are coextrusion of fluoropolymers and polyamides having an excess of amino end groups. The usual method of establishing an excess of amino end groups is addition of basic regulators (or of a slight excess of the diamine) during the polymerization process. Examples here are diamines such as hexamethylenediamine or decane- or dodecanediamines. A disadvantage here is that large amounts of regulator are needed to achieve a high NH₂ end group concentration, and because these become incorporated into the polyamide chain or onto the chain ends via reaction with COOH end groups they limit the molar mass, the consequence being that the resultant polyamides have excessively low viscosity. However, polyamides with a high viscosity are needed specifically for coextrusion with ETFE.

This can be achieved by avoiding use of low-molecular-weight amine regulators during the polymerization of the polyamide monomers, and instead using polymers having amino groups, i.e. polyamines. Examples of these polyamines are polyethyleneimines (e.g. obtainable as Lupasol® from BASF, DE). These are incorporated as what may be called polymeric regulators into the macromolecule, producing the polyamide-polyamine copolymer.

It has now been found that polyamide-polyamine copolymers to which amounts of from 0.5 to 1.5% by weight of polyethyleneimines have been added during the polymerization process or in the reaction mixture have very good adhesion to ETFE copolymers.

The polyamide-polyamine copolymers used for the inventive moulding composition for layer 2 advantageously comprise polycondensates composed of polyethyleneimines and of aliphatic lactams or ω-aminocarboxylic acids having from 4 to 44 carbon atoms, preferably from 4 to 18 carbon atoms, or polycondensates composed of aromatic ω-aminocarboxylic acids having from 6 to 20 carbon atoms.

A particularly suitable basis for the inventive polyamide-polyamine copolymers here is provided by homo- and copolyamides selected from PA 6, PA 11, PA 46, PA 12, PA 1212, PA 1012, PA 610, PA 612, PA 69, PA 6T, PA 6I, PA 10T, PA 12T, PA 12I, mixtures of these or copolymers based on these polyamides, preference being given to PA 11, PA 12, PA 1212, PA 10T, PA 12T and to copolymers based on the abovementioned polyamides, in particular PA 12T/12, PA 10T/12, PA 12T/106 and PT 10T/106. The basis for the inventive polyamide-polyamine copolymers may also be PA 6/66, PA 6/612, PA 6/66/610, PA 6/66/12, PA 6/6T and PA 6/6I. However, other conventional polymers may also be added to the polyamide-polyamine copolymers for particular purposes. They may moreover comprise the usual additives, such as UV stabilizers, heat stabilizers, crystallization accelerators, plasticizers, flame retardants, impact modifiers and lubricants.

Further polymers which may be present in the inventive polyamide-polyamine copolymer of the second layer 2 are functionalized polymers, among which are homo- or copolymers composed of olefins grafted with acrylic acid or with maleic anhydride.

The examples below illustrate the present invention but do not limit the same.

Materials Used for the Second Layer 2, Polyamide-polyamine Copolymer:

Polyamide unit: Laurolactam (providing underlying PA 12)

Polyamine: Polyethyleneimine (Lupasol, BASF, DE, cf. Table 1)

TABLE 1

| | Lupasol | Lupasol | Lupasol |
|---|---|---|---|
| | G100 | FG | G20wfr |
| Viscosity, 20° C. (mPa * s) | 1200 | 3000 | 5000 |
| Molar mass (g/mol) | 5000 | 800 | 1300 |
| Amino end groups (μeq/g) | 8000 | | 15 000 |
| Water content (%) | 50 | 1 | 1 |

wfr: anhydrous

Impact modifier: Ethylene-propylene copolymer grafted with maleic anhydride MVR 275° C./5 kg: 13 cm³/10 min (DIN ISO 1133: 1991) DSC melting point: 55° C.
   Process for Preparation of Starting Material for Second Layer 2, Polyamide-polyamine Copolymer;

The material was prepared in a 130 litre pressure reactor composed of mixer and polymerization autoclave. Laurolactam, regulator (polyethyleneimine, Lupasol) and water are added to the mixer and inertized repeatedly with nitrogen. The temperature is increased to 180° C., and the polymerization mixture is homogenized for 60 minutes. The temperature is then increased to 320° C., whereupon the ring-opening of the laurolactam takes place over a period of 5 hours at 20 bar. After depressurization to atmospheric pressure, the polymerization process takes place at 290° C. over a period of 2 hours under a current of nitrogen. A reduced pressure of 30 mbar is used at the end of the polymer preparation process to achieve a high degree of polymerization of the polyamide-polyamine copolymer.

The polyamide-polyamine copolymer may be used as adhesion promoter in relation to fluoropolymers either in pure form or else after addition of further modifiers, for example in order to increase impact strength (see Table 3). These modifiers may be added by way of a subsequent compounding process by means of conventional twin-screw extruders.

Determination of Properties of Resultant Material, in Particular in Composite with Further Layers:

The following specifications were used in carrying out tests on the inventive and non-inventive moulding compositions (comparative example):
MVR: (Melt volume rate) at 275° C./5 kg to ISO 1133; 1991
IR: Impact resistance to ISO 179/1eU
NIR: Notched impact resistance to ISO 179/1eA
Rel. Viscosity: measured on a 0.5% concentration by weight solution of the specimen in m-cresol to EN ISO 307

Yield stress, tensile strain at break and tensile modulus of elasticity were determined to ISO 527.

The adhesive values were determined via extrusion of a strip composed of two or three layers, ETFE (layer 1) and inventive polyamide-polyamine copolymer (layer 2), or ETFE (layer 1) and inventive polyamide-polyamine copolymer (layer 2) and PA12 polyamide (layer 3).

The ETFE copolymer used comprised Tefzel® 2202 from DuPont. This is a melt-processable copolymer composed of ethylene and TFE, which can be processed at high speeds.

The tables below give the compositions and the test data for the moulding materials (polyamide-polyamine copolymers) and of multilayer composites produced therefrom. The comparative example used a system in which a low-molecular-weight regulator (hexamethylenediamine) was added to the reaction mixture instead of the polyethyleneimine (as co-component and polymeric chain regulator). As can be seen from the relative viscosity in Table 2, the low-molecular-weight regulator retards chain growth at an early stage, thus preventing achievement of higher relative viscosities.

All of the data here are in % by weight.

TABLE 2
Polyamide-polyamine copolymers

| | | | | | | |
|---|---|---|---|---|---|---|
| 1 | 2 | 3 | 4 | 5 | 6 | Comparison 1 |

Reaction mixture

| | | | | | | | | |
|---|---|---|---|---|---|---|---|---|
| LAUROLACTAM | | 99 | 99.25 | 98.75 | 99 | 99.566 | 99.539 | 99.4 |
| LUPASOL G100 | | 1 | 0.75 | 1.25 | 1 | | | |
| (50% concentration) | | | | | | | | |
| LUPASOL FG | | | | | | 0.434 | | |
| LUPASOL G20WFR | | | | | | | 0.461 | |
| HEXAMETHYLENEDIAMINE | | | | | | | | 1.01 |
| (60%) | | | | | | | | |
| WATER | | 20 | 20 | 20 | 20 | 20 | 20 | 3.75 |
| Finished moulding | | | | | | | | |
| compositions | | | | | | | | |
| Water content | % | 0.02 | 0.02 | 0.01 | 0.02 | 0.03 | 0.02 | 0 |
| Rel. viscosity | — | 1.96 | 1.96 | 1.93 | 2.13 | 2.10 | 2.06 | 1.65 |
| (0.5%, m-cresol) | | | | | | | | |
| MVR (275° C./5 kg) | cm³/10 min | 28 | 25 | 22 | 14 | 20 | 46 | 70 |
| COOH end groups | μeq/g | 20 | 28 | 11 | 24 | 34 | 20 | 15 |
| NH₂ end groups | μeq/g | 108 | 88 | 119 | 98 | 64 | 99 | 100 |
| End group total | μeg/g | 128 | 116 | 130 | 122 | 98 | 119 | 115 |
| Methanol extract | % | 0.95 | 1.03 | 1.33 | 1.07 | 0.89 | 0.93 | 0.9 |
| Melting point | ° C. | 180 | 180 | 180 | 178 | 180 | 180 | 180 |

The following adhesions were measured in a peel test on two-layer strips:

Inventive: Layer 1/layer 2 in Inventive

### EXAMPLE 1 20 N

### Comparative Example

### Layer 1/layer 2 in Comparative Example 1 3 N

TABLE 3
Impact-resistant polyamide-polyamine copolymers

| | | 7 | 8 | C2 |
|---|---|---|---|---|
| Polyamide/polyamine | % | 90 | | |
| copolymer from | | | | |
| Inventive Example 4 | | | | |
| Polyamide/polyamine | % | | 90 | |
| copolymer from | | | | |
| Inventive Example 6 | | | | |
| Polyamide 12 from | % | | | 90 |
| Comparative Example | | | | |
| Impact modifier | % | 10 | 10 | 10 |
| Water content | % by wt | 0.015 | 0.018 | 0.018 |
| NH₂ end groups | μeq/g | 82 | 82 | 39 |
| COOH end groups | μeq/g | 30 | 22 | 19 |
| End group total | μeq/g | 112 | 104 | 58 |
| Methanol extract | % | 1.43 | 1.56 | 1.42 |
| MVR 275° C./21.6 kg | cm³/10 min | 100 | 280 | 160 |
| Rel. viscosity | — | 1.97 | 1.90 | 2.01 |
| (0.5%, m/cresol) | | | | |
| Tensile modulus of | MPa | 1250 | 1200 | 1150 |
| elasticity | | | | |
| Yield stress | MPa | 35 | 35 | 5 |
| Tensile strain at | % | 5 | 5 | 35 |
| yield stress | | | | |
| Ultimate tensile | MPa | 40 | 35 | 40 |
| strength | | | | |
| Tensile strain at | % | 115 | 115 | 200 |
| break | | | | |
| Impact resistance, | kJ/m² | No | No | No |
| 23° C. | | fracture | fracture | fracture |
| Impact resistance, | kJ/m² | No | No | No |
| −30° C. | | fracture | fracture | fracture |
| Notched impact | kJ/m² | 45 | 35 | 70 |
| resistance, 23° C. | | | | |
| Notched impact | kJ/m² | 13 | 12 | 17 |
| resistance, −30° C. | | | | |

Determination of Adhesion of Layer 2 in Relation to Layer 3, a Polyamide 12 Layer:

Two-layer experiments were carried out. Adhesion between the polyamide 12-polyamine copolymer layer and the polyamide 12 of the outer layer is so great, due to high chemical similarity, that these layers cannot be separated.

As shown by the inventive examples in Tables 2 and 3, only the use of polyamines as co-constituent in a polyamide-polyamine copolymer permits achievement of high viscosities for the polyamide and simultaneously an NH₂ end group concentration greater than 50 μeq/g. These two factors are, inter alia, important when multilayer systems composed of fluoropolymers such as ETFE and of polyamides are to be produced with good layer adhesion.

The adhesion values between fluoropolymer and polyamide-polyamine copolymer achieved using impact-modified polyamide-polyamine copolymers are the same as those achieved without impact modifier.

Key

1 Inner layer, first layer
2 Adhesion-promoter layer, second layer
3 Outer layer, third layer
4 Thermoplastic multilayer composite
5 Inner space
6 Outer space

1-27. (canceled)

28. A thermoplastic multilayer composite comprising:
a first layer comprising a fluoropolymer, and
a second layer, at least some regions of which have direct contact with the first layer,
wherein the second layer comprises a polyamide-polyamine copolymer.

29. A thermoplastic multilayer composite according to claim 28, wherein the fluoropolymer is selected from tetrafluoroethylene (TFE), hexafluoropropylene (HFP), vinyl fluoride (VF), perfluorinated methyl vinyl ether (PMVE), vinylidene fluoride (VDF), and a mixture thereof,
wherein the fluoropolymer is optionally a copolymer with ethylene.

30. A thermoplastic multilayer composite according to claim 28, wherein the first layer is a layer comprising an ethylene-tetrafluoroethylene copolymer (ETFE) or polyvinylidene fluoride (PVDF).

31. A thermoplastic multilayer composite according to claim 28, wherein the inner layer is a layer comprising a fluoropolymer and not modified with respect to adhesion.

32. A thermoplastic multilayer composite according to claim 28, wherein the multilayer composite is in the form of a hollow body or of a coating.

33. A thermoplastic multilayer composite according to claim 32, wherein the multilayer composite is in the form of a hollow body and the first layer is a layer facing towards the inner side of the hollow body.

34. A thermoplastic multilayer composite according to claim 28, wherein at least some regions of the second layer also directly adjoin a third layer comprising a polyamide.

35. A thermoplastic multilayer composite according to claim 34, wherein at least one of the monomers of the polyamide-polyamine copolymer of the second layer is the same as at least one of the monomers in the polyamide polymer of the third layer.

36. A thermoplastic multilayer composite according to claim 35, wherein at least 95% of the polyamide-forming monomers of the second layer and of the third layer are identical.

37. A thermoplastic multilayer composite according to claim 34, wherein the multilayer composite is a hollow body, wherein the first layer is a layer at least indirectly facing towards the inner side of the hollow body, and wherein the third layer is a layer at least indirectly facing towards the outer side of the hollow body.

38. A thermoplastic multilayer composite according to claim 37, wherein one surface of the first layer is essentially in full contact with one surface of the second layer and another surface of the second layer is essentially in full contact with one surface of the third layer.

39. A thermoplastic multilayer composite according to claim 28,
wherein, optionally, at least some regions of the second layer also directly adjoin a third layer comprising a polyamide, and
wherein the polyamide-polyamine copolymer of the second layer and/or the polyamide of the optional third layer are polymers or polycondensates comprising aliphatic lactams, ω-aminocarboxylic acids having from 4 to 44 carbon atoms, or aromatic ω-aminocarboxylic acids having from 6 to 20 carbon atoms.

40. A thermoplastic multilayer composite according to claim 39, wherein the ω-aminocarboxylic acids have from 4 to 18 carbon atoms.

41. A thermoplastic multilayer composite according to claim 40, wherein the ω-aminocarboxylic acids have 12 carbon atoms.

42. A thermoplastic multilayer composite according to claim 28,
wherein, optionally, at least some regions of the second layer also directly adjoin a third layer comprising a polyamide, and
wherein the polyamide-polyamine copolymer of the second layer and/or the polyamide of the optional third layer are polycondensates comprising at least one diamine and at least one dicarboxylic acid, the diamine and the dicarboxylic acid having each from 2 to 44 carbon atoms.

43. A thermoplastic multilayer composite according to claim 42, wherein the diamine is at least one of the diamines selected from the following group: ethylenediamine, 1,4-diaminobutane, 1,6-diaminohexane, 1,10-diaminodecane, 1,12-diaminododecane, m- and p-xylylenediamine, cyclohexyldimethyleneamine, bis(p-aminocyclohexyl)methane and their alkyl derivatives, and/or the dicarboxylic acid is one or more of the following dicarboxylic acids: succinic, glutaric, adipic, pimelic, suberic, azelaic and sebacic acid, dodecanedicarboxylic acid, 1,6-cyclohexanedicarboxylic acid, terephthalic acid, isophthalic acid and naphthalenedicarboxylic acid.

44. A thermoplastic multilayer composite according to claim 28,
wherein, optionally, at least some regions of the second layer also directly adjoin a third layer comprising a polyamide, and
wherein the basis for the polyamide-polyamine copolymer of the second layer and/or the polyamide of the optional third layer are homo- and/or copolyamides selected from PA 6, PA11, PA 46, PA 12, PA 1212, PA 1012, PA 610, PA 612, PA 69, PA 6T, PA 61, PA 10T, PA 12T, PA 121, mixtures of these and copolymers comprising these polyamides.

45. A thermoplastic multilayer composite according to claim 44, wherein the homo- and/or copolyamides are selected from PA 11, PA 12, PA 1212, PA 10T, PA 12T and copolymers comprising the abovementioned polyamides.

46. A thermoplastic multilayer composite according to claim 45, wherein the copolyamides are selected from PA 12T/12, PA 10T/12, PA 12T/106 and PA 10T/106.

47. A thermoplastic multilayer composite according to claim 28,
wherein, optionally, at least some regions of the second layer also directly adjoin a third layer comprising a polyamide, and
wherein the polyamide basis of the polyamide-polyamine copolymer of the second layer and/or the polyamide of the optional third layer are PA 6/66, PA 6/612, PA 6/66/610, PA 6/66/12, PA 6/6T, PA 6/6I, or mixtures thereof.

48. A thermoplastic multilayer composite according to claim 28,
wherein, optionally, at least some regions of the second layer also directly adjoin a third layer comprising a polyamide, and
wherein the polyamide-polyamine copolymer of the second layer and/or the polyamide of the optional third layer are polymers to which one or more polymers have been added, and/or to which one or more UV stabilizers, heat stabilizers, crystallization accelerators, plasticizers, flame retardants, impact modifiers or lubricants, have been added.

49. A thermoplastic multilayer composite according to claim 48, wherein the one or more polymers added are polymers or copolymers comprising a polyolefin grafted with acrylic acid or grafted with maleic anhydride.

50. A thermoplastic multilayer composite according to claim 28, wherein the polyamine used to prepare the polyamide-polyamine copolymer for the second layer is selected from polyvinylamines, polyamines derived from alternating polyketones, dendrimers, and linear and branched polyethyleneimines.

51. A thermoplastic multilayer composite according to claim 50, wherein the polyamine used to prepare the polyamide-polyamine copolymer for the second layer is selected from linear and branched polyethyleneimines with a molar mass in the range from 500 to 25,000 g/mol.

52. A thermoplastic multilayer composite according to claim 51, wherein the molar mass of the polyamine used to prepare the polyamide-polyamine copolymer for the second layer is in the range from 800 to 5000 g/mol.

53. A thermoplastic multilayer composite according to claim 51, wherein the polyamine used to prepare the polyamide-polyamine copolymer for the second layer has a viscosity in the range from 1200 to 5000 mpa*s at 20° C.

54. A thermoplastic multilayer composite according to claim 28, wherein the moulding composition of the second layer has an amino end group concentration in the range from 50 to 300 μeq/g.

55. A thermoplastic multilayer composite according to claim 28, wherein the moulding composition of the second layer has a volume flow index of from 10 to 50 cm³/10 min at 275° C./5 kg according to ISO 1133, or a volume flow index of from 50 to 500 cm³/10 min at 275° C./5 kg according to ISO 1133.

56. A thermoplastic multilayer composite according to claim 28, wherein the moulding composition of the second layer has a volume flow index of from 10 to 50 cm³/10 min at 275° C./5 kg according to ISO 1133 when the thermoplastic multilayer composite is used for a pipe or a container.

57. A thermoplastic multilayer composite according to claim 28, wherein the moulding composition of the second layer has a volume flow index of from 50 to 500 cm³/10 min at 275° C./5 kg according to ISO 1133 when the thermoplastic multilayer composite is used for the coating of an optical conductor.

58. A thermoplastic multilayer composite according to claim 28, wherein the first layer has been rendered antistatic via admixture of carbon black particles or graphite particles.

59. A thermoplastic multilayer composite according to claim 28, wherein the moulding composition of the second layer comprises a polyamine in an amount of from 0.2 to 5% by weight, as co-component in the polyamide-polyamine copolymer.

60. A thermoplastic multilayer composite according to claim 59, wherein the polyamine is polyethyleneimine.

61. A thermoplastic multilayer composite according to claim 59, wherein the moulding composition of the second layer comprises a polyamine in an amount of from 0.4 to 1.5% by weight.

62. A thermoplastic multilayer composite according to claim 59, wherein the remaining non-polyamine co-fractions of the copolymer comprise a polyamide.

63. A method of providing adhesion between two substrates comprising placing a substrate comprising a layer, which comprises a polyamide-polyamine copolymer in contact with a fluoropolymer substrate.

64. A method according to claim 63, wherein the layer comprising a polyamide-polyamine copolymer comprises a polyamide-polyethyleneimine copolymer.

65. A method according to claim 63, wherein the adhesion is between a substrate comprising a fluoropolymer and a layer comprising a polyamide.

66. A fluid-conveying pipe or container comprising a thermoplastic multilayer composite according to claim 28.

67. A fluid-conveying pipe or container according to claim 66, wherein the pipe or container is designed for the motor vehicle sector.

68. A fluid-conveying pipe or container according to claim 66, wherein the fluid-conveying pipe or container is a fuel pipe.

69. A fluid-conveying pipe or container according to claim 68, wherein the fuel pipe is a gasoline or diesel pipe.

70. A coating of optical conductors comprising a thermoplastic multilayer composite according to claim 28.

71. A coating of an optical conductor according to claim 70, wherein the optical conductor has an optical core comprising PMMA.

72. A polymer piping comprising a multilayer composite according to claim 28, wherein the first layer is at least indirectly an inner layer with a thickness in the range from 0.01 to 0.7 mm, the second layer, in contact therewith, is an adhesive-promoter layer with a thickness of from 0.05 to 0.3 mm, and further comprising a third layer, which is, at least indirectly, an outer layer with a thickness of from 0.2 to 0.8 mm.

73. A polymer piping comprising a multilayer composite according to claim 28, wherein at least one of the layers is electrically conducting and/or wherein the inner side of the first layer has another, innermost layer, which is electrically conductive.

74. A polymer piping according to claim 73, wherein the electrically conducting layer is the inner layer.

75. A process for the production of a hollow body comprising a thermoplastic multilayer composite according to claim 28, comprising placing the first layer comprising a fluoropolymer in contact with the second layer comprising a polyamide-polyamine copolymer, and optionally further comprising placing a third layer in contact with the second layer, and optionally further comprising placing one or more inner layers or one or more outer layers in contact with the thermoplastic multilayer composite product of the previous steps.

76. A process according to claim 75, wherein, for the preparation of the moulding composition for the second layer, a lactam, the polyamine, and also water, are first homogenized at an elevated temperature, and then, at a further elevated temperature above 300° C., are polymerized for two or more hours at an elevated pressure, and also then brought to atmospheric pressure and a lower temperature, to give the polyamide-polyamine copolymer.

77. A process according to claim 76, wherein the polyamine is a polyethyleneimine.

78. A process according to claim 75, wherein the first layer, the second layer, and also, if appropriate, the third layer, and, if appropriate, other outer or inner layers, are joined in a coextrusion process.

79. A process according to claim 78, wherein the product of the process is a pipe or a container.
